(19) United States
(12) Patent Application Publication
(10) Pub. No.: US 2012/0286489 A1
(43) Pub. Date: Nov. 15, 2012

(54) TOOLBOX AND FILING SYSTEM

(76) Inventor: Kerry Bartholomew, Hammonton, NJ (US)

(21) Appl. No.: 13/107,448

(22) Filed: May 13, 2011

(51) Int. Cl. B25H 3/02; B62B 1/00

(52) U.S. Cl. 280/47.131; 206/372; 206/376

(57) ABSTRACT

The present invention is a tool box and filing system that includes a tool file that includes a plurality of holding files, a handle disposed on top of the tool file, a side edging to provide an airtight seal, a plurality of elongated holding strips and a plurality of tools secured within the holding files by the holding strips. The system also includes an airtight tool file box that includes a handle, a pair of locks to secure the tool file box and an airtight lid that is secured by the locks. The handle is disposed on the top and middle of the lid and the tool file is stored within the tool file box. The tool file box can also have a set of wheels and a horizontal storage compartment tray stored within the tool file box to accommodate larger tools.

### TECHNICAL FIELD & BACKGROUND

Standard tool boxes and tool buckets offer limited solutions for properly separating and storing tools in an organized and readily accessible manner. When utilizing a conventional tool box or bucket, one must often empty the contents to locate the desired tool, which can be time consuming.

The present invention generally relates to a toolbox. More specifically, the invention is a toolbox with a filing system.

It is an object of the invention to provide a toolbox with a filing system that features a container that systematically stores tools using labeled files that are equipped with elongated holding strips and an airtight lid and lock.

It is an object of the invention to provide a toolbox with a filing system that makes every tool equally accessible to store without damage.

It is an object of the invention to provide a toolbox with a filing system with a cable lock, allowing the box to be secured in the bed of a pickup truck or to a fixed object at the job site.

What is really needed is a toolbox with a filing system that features a container that systematically stores tools using labeled files that are equipped with hard plastic fasteners to snap into integrated slots, and an airtight lid and lock, that makes every tool equally accessible to store without damage and allowing the box to be secured in the bed of a pickup truck or to a fixed object at the job site.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front perspective view of a tool file of a toolbox and filing system, in accordance with one embodiment of the present invention.

FIG. 2 illustrates a front side perspective view of a tool file box of a toolbox and filing system, in accordance with one embodiment of the present invention.

FIG. 3 illustrates a side perspective view of a tool file box of a toolbox and filing system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

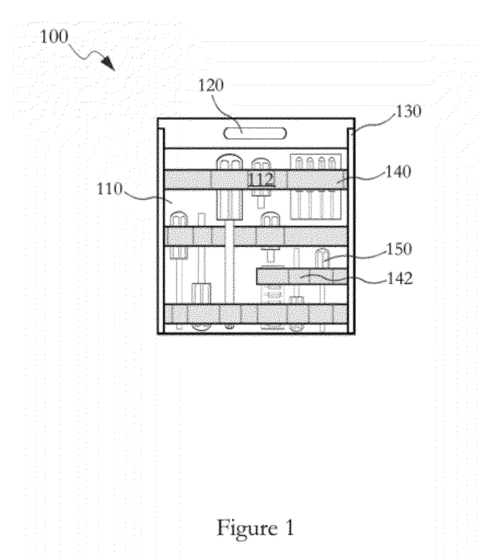

FIG. 1 illustrates a front perspective view of a tool file 100 of a toolbox and filing system, in accordance with one embodiment of the present invention. The tool file 100 includes a plurality of holding files 110, a handle 120, a side edging 130, a plurality of holding strips 140 and a plurality of tools 150.

The holding files 110 are made of canvas or other suitable material. The holding files 110 can also be provided with labeling indicia 112 such as the name or type of the tool being held. The handle 120 is a flip-up type handle that can be any suitable type of handle. The side edging 130 is made of hard plastic or other suitable material. The holding strips 140 are elongated and secure the tools 150 within the holding files 110. The holding strips 140 can also incorporate and utilize hook and loop Velcro™ fasteners 142. The tools 150 can be basic tools such as hammers, screw drivers, wrenches or any other suitable basic tools.

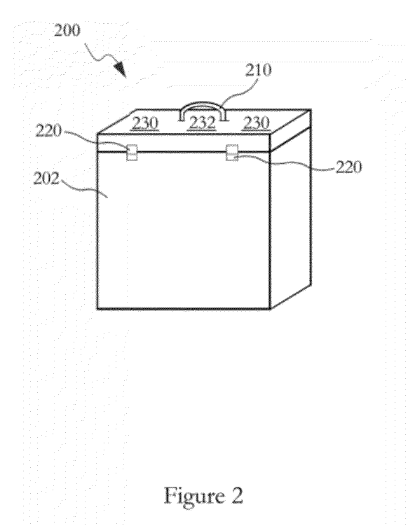

FIG. 2 illustrates a front side perspective view of a tool file box 200 of a toolbox and filing system, in accordance with one embodiment of the present invention. The tool file box 200 includes a handle 210, a plurality of locks 220 and a lid 230. The tool file box 200 utilizes the same holding files and holding strips illustrated in FIG. 1 and its description. The handle 210 can be a flip-up type handle or other suitable type of handle that can be used to carry the tool file box 200. The locks 220 include two locks disposed on the front side 202 of the tool file box 200, although any number of suitable locks can be used. There is also a lid 230 that is air tight and secured by the locks 220 and the handle 210 that is disposed typically in the middle 232 of the lid 230. The tool file box 200 is made of hard plastic although other suitable materials can be used. The tool file box 200 can also be secured to a truck or other fixed object by a cable lock or chain lock (not shown).

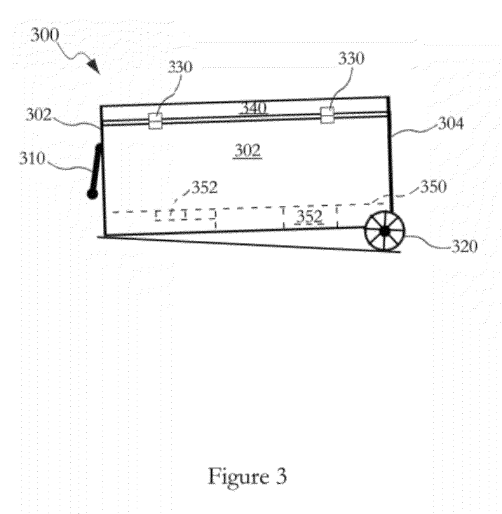

FIG. 3 illustrates a side perspective view of a tool file box 300 of a toolbox and filing system, in accordance with one embodiment of the present invention. The tool file box 300 includes a handle 310, a pair of wheels 320, a plurality of locks 330, a lid 340 and a storage compartment 350. The tool file box 300 utilizes the same holding files and holding strips illustrated in FIG. 1 and its description. The handle 310 is a flip-up handle although any suitable type of handle can be utilized. The handle 310 is also disposed on one side 302 of the tool file box 300 in contrast to being disposed on the top of the lid of the tool file box 200, as illustrated and described in FIG. 2. The pair of wheels 320 are disposed on the bottom of the opposite side 304 of the tool file box 300 to facilitate carrying relatively heavier tools than the tools carried in the tool file 200, as illustrated and described in FIG. 2.

The locks 330 include two locks disposed on the front side 202 of the tool file box 200, although any number of suitable locks can be used. The lid 340 is air tight and secured by the locks 330. The storage compartment 350 is a horizontal tray with a plurality of various sized sections 352 that can accommodate and store relatively heavier tools. The storage compartment 350 stores power drills, power saws, hand saws, crow bars, levels, extension cords, drop lights and battery chargers and other suitable relatively heavier tools than the tools stored in the holding files (FIG. 1, 110). The storage compartment 350 is set inside on the bottom of the tool file box 300. The tool file box 300 is relatively larger than the tool file box illustrated in FIG. 2 and its description and is generally rectangular shaped. The tool file box 300 is made of hard plastic although other suitable materials can be used.

The files contained inside of the tool file box are constructed of brightly colored canvas with plastic on the sides and are equipped with elastic strips and pockets of various sizes to accommodate any standard and specialty tool or material. A file can be slid out of the tool file box by utilizing a built-in handle and can be placed behind the elastic strips. A particular tool and/or tool category can be placed and labeled directly onto the file, to facilitate returning the tool to its correct corresponding slot, thereby eliminating wasted time searching for specific tools. The tool file box is outfitted with hard wheels on the bottom of one side and a handle on the top of the opposite side, providing relatively easy portability to the user.

Unlike a standard toolbox or bucket, the tool file box combines a tool box and file cabinet to organize hand tools into separate files within the tool file box according to categories, such as screwdrivers, electrical, plumbing, wrenches and bits where they can be stored, accounted for, and retrieved quickly. The tool file box allows owners to store their tools in an orderly manner eliminating lost time wasted in searching for tools regardless of how often or seldom there used. The tool file box can be customized to different trades such as general construction, electrical, plumbing, HVAC as well as for a hobbyist or Dad who does week-end projects. The tool file box also allows owners to store their tools without risk of damage from improper storage and protects tools from rusting due to exposure to weather and humidity in the airtight tool file box. The tool file box will allow owners to quickly account for their tools prior to leaving a job site preventing loss of tools and replacement costs.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A tool box and filing system, comprising:
a tool file with a top and two sides that includes a plurality of holding files, a handle disposed on top of said tool file, a side edging disposed on said sides to provide an airtight seal, a plurality of elongated holding strips and a plurality of tools secured within said holding files by said holding strips; and
an airtight tool file box with a front that includes a handle, a pair of locks to secure said tool the box and an airtight lid with a top and a middle that is secured by said locks, wherein said handle is disposed on said top and middle of lid and said tool file is stored within said tool the box.

2. The system according to claim 1, wherein said holding files are made of canvas.

3. The system according to claim 1, wherein said holding files are provided with labeling indicia of said tool name and type being held.

4. The system according to claim 1, wherein said tool file handle is a flip-up type of handle.

5. The system according to claim 1, wherein said side edging is made of hard plastic.

6. The system according to claim 1, wherein said holding strips incorporate hook and loop fasteners.

7. The system according to claim 1, wherein said tools include hammers, screw drivers and wrenches.

8. The system according to claim 1, wherein said tool file box handle is a flip-up type handle.

9. The system according to claim 1, wherein said tool the box is made of hard plastic.

10. A tool box and filing system, comprising:
a tool the with a top and two sides that includes a plurality of holding files, a handle disposed on top of said tool file, a side edging disposed on said sides to provide an airtight seal, a plurality of elongated holding strips and a plurality of tools secured within said holding files by said holding strips; and
an airtight tool file box with a front, two sides and a bottom that includes a handle disposed on one said side, a pair of locks to secure said tool file box, a pair of wheels disposed on said bottom of other said side, a horizontal storage compartment tray and an airtight lid that is secured by said locks, said tool file and said storage compartment are stored within said tool file box.

11. The system according to claim 10, wherein said holding files are made of canvas.

12. The system according to claim 10, wherein said holding files are provided with labeling indicia of said tool name and type being held.

13. The system according to claim 10, wherein said tool file handle is a flip-up type of handle.

14. The system according to claim 10, wherein said side, edging is made of hard plastic.

15. The system according to claim 10, wherein said holding strips incorporate hook and loop fasteners.

16. The system according to claim 10, wherein said tools secured in said tool file include hammers, screw drivers and wrenches.

17. The system according to claim 10, wherein said tool the box handle is a flip-up type handle.

18. The system according to claim 10, wherein said horizontal storage compartment tray includes a plurality of various sized sections.

19. The system according to claim 18, wherein said horizontal storage compartment tray stores power drills, power saws, hand saws, crow bars, levels, extension cords, drop lights and battery chargers.

20. The system according to claim 10, wherein said tool file box is made of hard plastic.
